(19) United States
(12) Patent Application Publication
(10) Pub. No.: US 2006/0131089 A1
(43) Pub. Date: Jun. 22, 2006

(54) Device used for limiting the speed of an electric cart while the cart is turning

(76) Inventor: Samuel Lin, Chia Yi City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/017,952

(22) Filed: Dec. 22, 2004

(51) Int. Cl. B62D 51/04

(52) U.S. Cl. 180/170

(57) ABSTRACT

A speed limiting device of an electric cart includes a measuring mechanism used for measuring an angle, at which the cart is turning, a conversion mechanism, a comparer, and a switch; the conversion mechanism can perform calculation based on both an input angle and a predetermined centrifugal speed to obtain a maximum allowed speed; the switch is connected to a motor of the cart; first and second alternative contacts are provided for the switch to selectively touch; the first contact is connected to the output terminal of the conversion mechanism; the present speed value is sent to the second contact and the comparer, which can make a comparison between the present speed and the maximum speed, according to the result of which comparison the switch will touch either one of the contacts, thus making the cart run at a smaller one of the above two speeds when the cart is turning.

### BACKGROUND OF THE INVENTION

1. Field of the Invention

The present invention relates to a speed limiting device of an electric cart, which can perform a calculation based on an angle, at which the cart is turning, to obtain a maximum allowed speed, and next make the cart move at a smaller one of the present speed and the maximum allowed speed, thus preventing the cart from moving at such a high speed as to fall over while it is turning.

2. Brief Description of the Prior Art

Electric carts are very convenient personal vehicles for leg-handicapped people and the elderly, and they are more strength saving and convenient to use than conventional wheelchairs because they are electrically actuated.

However, because common electric carts have a relatively high center of gravity, they might fall over if they move at high speed while turning. And, because common electric carts aren't equipped with any protection around the riders, the riders are prone to get injured should the carts fall over.

### SUMMARY OF THE INVENTION

It is a main object of the invention to provide a device, which can limit the speed of an electric cart when the cart is turning.

The speed limiting device of the present invention includes a measuring mechanism used for measuring an angle, at which the cart is turning, a conversion mechanism, a comparer, and a switch. The conversion mechanism can perform calculation based on both an input angle value and a predetermined centrifugal speed value to obtain a maximum allowed speed. The switch is connected to a motor of the cart while first and second alternative contacts are provided for the switch to selectively touch. The first contact is connected to the output terminal of the conversion mechanism, and the present speed value is sent to the second contact and the comparer, which can make a comparison between the present speed and the maximum speed, according to the result of which comparison the switch will touch either one of the contacts, thus making the cart run at a smaller one of the two speeds when the cart is turning.

### BRIEF DESCRIPTION OF THE DRAWINGS

The present invention will be better understood by referring to the accompanying drawings, wherein:

FIG. 1 is a circuit diagram of the speed limiting device of an electric cart according to the present invention.

### DETAILED DESCRIPTION OF THE PREFERRED EMBODIMENTS

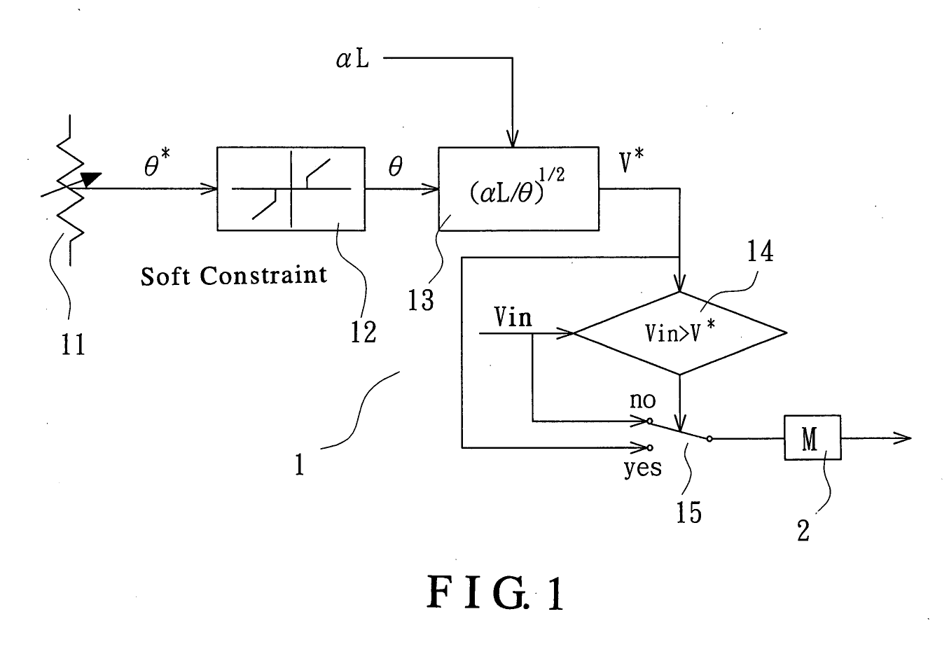

Referring to FIG. 1, a preferred embodiment 1 of a speed limiting device of an electric cart, which is provided for a person to ride on, includes an electrical potential measuring mechanism 11, a soft constraint 12, a speed conversion mechanism 13, a comparer 14, and a switch 15. The speed limiting device 1 is disposed between an axle of front wheels and handlebars of the electric cart (not shown).

The electrical potential measuring mechanism 11 is used for measuring the angle, at which the electric cart is turning. The soft constraint 12 is connected to an output terminal of the electrical potential measuring mechanism 11 at an input terminal thereof, and it is set such that if an input angle value is smaller than the absolute value of predetermined angle values, e.g. ±5°, the input angle value will be considered to be the result of slight shaking of the cart, and neglected.

The speed conversion mechanism 13 is connected to an output terminal of the soft constraint 12 at an input terminal thereof, and a predetermined centrifugal speed value has been already input in the speed conversion mechanism 13 before the device 1 is put into use. The speed conversion mechanism 13 will perform a calculation based on an input angle value (θ), at which the electric cart is turning, and the predetermined centrifugal speed value (αL) as well as a formula: the maximum allowed speed=√(αL/θ), i.e. √ (the predetermined centrifugal speed value/ the input angle value). Consequently, the maximum allowed speed is obtained through the above calculation.

The comparer 14 is connected to an output terminal of the speed conversion mechanism 13 at an input terminal thereof. And, the output terminal of the speed conversion mechanism 13 is connected to a first one of two alternative contacts for the switch 15. The comparer 14 is connected to the switch 15 at an output terminal thereof for controlling the switch 15. The switch 15 is connected to a motor 2 of the electric cart at an output terminal thereof. Furthermore, the current speed value of the cart will be sent to a second one of the two alternative contacts for the switch 15.

The present speed value of the cart is sent to the comparer 14, and the comparer 14 will make a comparison between the current speed of the cart and the input maximum allowed speed. If the input maximum allowed speed is greater than the current speed, the comparer 14 will make the switch 15 touch the second one of the two alternative contacts; thus, the motor 2 won't change the speed, and the cart will still move at the current speed while turning. If the input maximum allowed speed is smaller than the current speed, the comparer 14 will make the switch 15 touch the first one of the two alternative contacts; thus, the motor 2 will change the speed so that the cart moves at the maximum allowed speed instead of the current speed while turning.

Therefore, when the electric cart is turning at a certain angle that is greater than 5°, the present speed limiting device will perform a calculation base on said certain angle as well as the predetermined centrifugal speed value to obtain a maximum allowed speed, and next the device will make the cart move at the maximum allowed speed instead if the current speed is greater than the maximum allowed speed; thus, the cart will move at such a speed as not to fall over while turning.

From the above description, it can be easily understood that because of the speed limiting device of the invention, while turning, the cart won't move so fast as to cause discomfort to the rider, and the risk of the electric cart falling over while turning is eliminated, and the cart is safer to ride on.

What is claimed is:

1. A device used for limiting speed of an electric cart when the cart is turning,
the device being arranged between an axle of front wheels and handlebars of the electric cart; the device comprising
an electrical potential measuring mechanism used for measuring an angle, at which the electric cart is turning;
a soft constraint connected to an output terminal of the electrical potential measuring mechanism at an input terminal thereof; the soft constraint being set such that if an angle value, at which the electric cart is turning, is smaller than a predetermined value, the input angle value will be considered to be a result of slight shaking of the cart, and neglected.
a speed conversion mechanism connected to an output terminal of the soft constraint at an input terminal thereof; a predetermined centrifugal speed value having been already input in the conversion mechanism; the conversion mechanism being capable of performing a calculation based on both an input angle value and the predetermined centrifugal speed value to obtain a maximum allowed speed;
a comparer connected to an output terminal of the speed conversion mechanism at an input terminal thereof; and
a switch connected to a motor of the electric cart at an output terminal thereof; an output terminal of the comparer being connected to the switch for controlling the switch; two alternative contacts being provided for the switch to selectively touch either one; a first one of the alternative contacts being connected to the output terminal of the speed conversion mechanism; a present speed value of the cart being sent to both the comparer and a second one of the alternative contacts;
the comparer being capable of making a comparison between a present speed of the electric cart and an input maximum allowed speed, according to a result of which comparison the comparer will make the switch touch either one of the two alternative contacts such that the cart will run at a smaller one of the present speed and the maximum allowed speed obtained from the calculation;
whereby speed of the cart can be limited when the cart is turning.
